(19) United States
(12) Patent Application Publication
(10) Pub. No.: US 2022/0044329 A1
(43) Pub. Date: Feb. 10, 2022

(54) Predictive System for Request Approval

(71) Applicant: 3M INNOVATIVE PROPERTIES COMPANY, St. Paul, MN (US)

(72) Inventors: Nicolas M. Bertagnolli, Riverton, UT (US); Dominick R, Rocco, Minneapolis, MN (US); Cody A. Coonradt, Sandy, UT (US)

(21) Appl. No.: 17/309,419

(22) PCT Filed: Nov. 22, 2019
(86) PCT No.: PCT/IB2019/060078

§ 371 Date: May 26, 2021

Related U.S. Application Data
(60) Provisional application No. 62/773,784, filed on Nov. 30, 2018.

(51) Int. Cl. G06Q 40/08; G06F 40/284; G06N 3/02

(52) U.S. Cl. CPC G06Q 40/08; G06N 3/02; G06F 40/284

(57) ABSTRACT

A computer implemented method includes receiving a text-based request from a first entity for approval by a second entity-based compliance with a set of rules, converting the text-based request to create a machine compatible converted input having multiple features, providing the converted input to a trained machine learning model that has been trained based on a training set of historical converted requests by the first entity, and receiving a prediction of approval by the second entity from the trained machine learning model along with a probability that the prediction is correct.

### BACKGROUND

Claim denials are a major pain point for hospitals costing the industry an estimated 262 billion dollars annually. According to a 2016 HIMSS Analytics survey of 63 hospitals less than half of all hospitals use a claims denial management service with 31% using an entirely manual process. Hospitals are virtually shooting in the dark when it comes to estimating if a claim is likely to be denied. This leads to expensive claim readjustments and resubmissions.

Insurance providers generally reject about 9% of all hospital claims putting the average hospital at risk of losing about $5 million annually. In general hospitals recoup about 63% of these denied claims at an average cost of about $118 per claim. Being able to affect this even slightly can have huge payoffs.

### SUMMARY

A computer implemented method includes receiving a text-based request from a first entity for approval by a second entity-based compliance with a set of rules, converting the text-based request to create a machine compatible converted input having multiple features, providing the converted input to a trained machine learning model that has been trained based on a training set of historical converted requests by the first entity, and receiving a prediction of approval by the second entity from the trained machine learning model along with a probability that the prediction is correct.

In a further embodiment, a computer implemented method includes receiving text-based requests from a first entity for approval by a second entity-based compliance with a set of rules, receiving corresponding text-based responses of the second entity-based on the text-based requests, extracting features from the text-based requests and responses, and providing the extracted features to an unsupervised classifier to identify key features corresponding to denials or approval by the second entity.

### BRIEF DESCRIPTION OF THE DRAWINGS

FIG. 1 is a flowchart of a computer implemented method for predicting whether a text-based request will be approved or denied according to an example embodiment.

FIG. 2 is a flowchart illustrating a computer implemented method of identifying relevant features according to an example embodiment.

FIG. 3 is a block flow diagram illustrating the training and use of a model for predicting request fate and providing identification of portions of requests that are more likely to lead to approval according to an example embodiment.

FIG. 4 is a flowchart illustrating a further computer implemented method of categorizing request outcomes according to an example embodiment.

FIG. 5 is a block flow diagram illustrating a system for categorizing request outcomes according to an example embodiment.

FIG. 6 is a block flow diagram illustrating a further example of categorizing requests according to an example embodiment.

FIG. 7 is a block diagram of an example of an environment including a system for neural network training according to an example embodiment.

FIG. 8 is a block schematic diagram of a computer system to implement request approval prediction process components and for performing methods and algorithms according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Requests for approval are expressed by human submitters in text form. Such requests may include a claim for insurance reimbursement, approval for a trip in a company, approval to promote a person, or many other types of requests. Such requests are usually processed by a request processing person in a separate organization, such as a claims processor for an insurance company, a manager, a supervisor or other person. The request processing person may be following a set of rules or procedures to determine whether or not the request should be approved or denied based on those rules or procedures. The request processing person reviews the text of the requests against such rules and tries to apply the rules as best they can. Some requests may be automatically processed by a programmed computer. The person submitting the requests may not be familiar with all the rules or the manner in which the requests are processed. As such, it can be difficult for the submitter to determine why a specific request was denied or approved.

A machine learning system is used to analyze text-based requests from a first entity for approval by a second entity. The request is tokenized to create a tokenized input having multiple features. A feature extractor such as TF-IDF (term frequency-inverse document frequency) may be used, or more complex feature extraction methods, such as domain experts, word vectors, etc., may be used. The tokenized input is provided to the machine learning system that has been trained on a training set of historical tokenized requests by the first entity. The system provides a prediction of approval by the second entity along with a probability that the prediction is correct.

A further system receives text-based requests from the first entity for approval by the second entity-based compliance with a set of rules. Corresponding text-based responses of the second entity-based on the text-based requests are received. Features are extracted from the text-based requests and responses. The extracted features are provided to an unsupervised classifier to identify key features corresponding to denials or approval by the second entity. The identified key features are provided to the first entity to enable the first entity to improve text-based requests for a better chance at approval by the second entity.

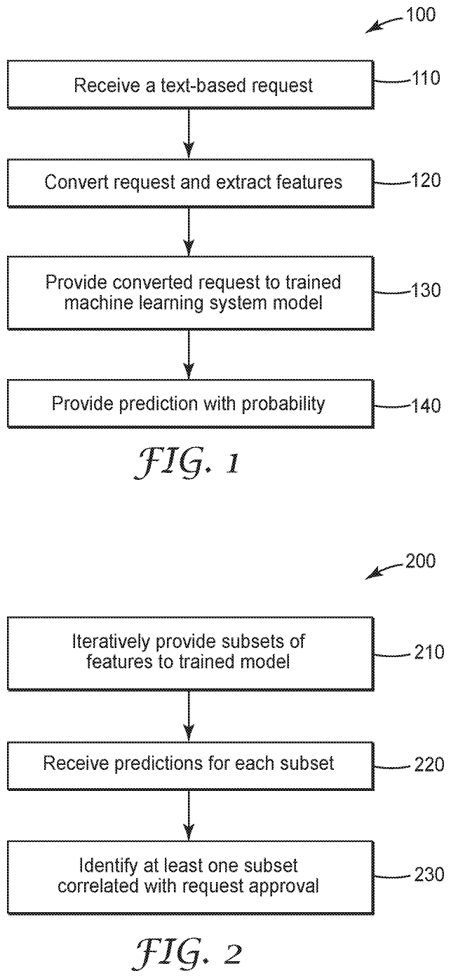

FIG. 1 is a flowchart of a computer implemented method 100 for predicting whether a text-based request will be approved or denied. Method 100 begins by receiving a text-based request at operation 110 from a first entity for approval by a second entity-based compliance with a set of rules. The text-based request in one example may be an insurance claim prepared by an employee or programmed computer at the first entity. The request may be in the form of a narrative, such as a paragraph describing an encounter with a patient having insurance. The request may alternatively be in the form of a table, database structure, or other format and may include alphanumeric text, such as language text, numbers, and other information.

The first entity may be a health care provider, such as a clinic or hospital, or a department within the provider. While the request is being described in the context of healthcare, many other types of request may be received and processed by a computer implementing method 100 in further examples referred to above.

At operation 120, the text-based request is converted to create a machine compatible converted input having multiple features. Converting the text-based request comprises separating punctuation marks from text in the request and treating individual entities as tokens. The conversion may take the form of tokenization. Tokenization may assign numeric representations to words or individual letters in various embodiments to create a vectorized representation of the tokens. Punctuation may also be tokenized. By assigning numbers via the conversion, the request is placed in a form that a computer can more easily process. The conversion may be performed by a natural language processing machine.

At operation 130, the converted input is provided to a trained machine learning model that has been trained based on a training set of historical converted requests by the first entity. In various examples, the machine learning model is a deep learning model having various depths, a recurrent neural network comprised of long short-term memory units or gated recurrent units, or a convolutional neural network.

The trained machine learning model provides at operation 140, a prediction of approval by the second entity from the trained machine learning model along with a probability that the prediction is correct.

At operation 120, features may be extracted from the machine learning model by various methods. The features may be identified as being helpful in obtaining approval of a request to allow the first entity to modify a request before submitting the request to the second entity for approval. In one example, feature extraction is performed by using frequency—inverse document frequency to form a vectorized representation of the tokens. In a further example, features are extracted using a neural word embedding model such as Word2Vec, GloVe, BERT, ELMO, or a similar model.

FIG. 2 is a flowchart illustrating a computer implemented method 200 of identifying relevant features. At 210, different subsets of the multiple features are iteratively provided to the trained machine learning model. Iteratively providing different subsets of the multiple features may be performed using n-gram analysis. Predictions and corresponding probabilities are received at operation 220 for each of the provided different subsets. At operation 230, at least one subset is identified that is correlated with approval of the request. Multiple subsets may be identified as helpful with obtaining approval of the request.

Several examples of requests in the form of claims for reimbursement in a medical insurance setting are described below. The first entity provides the text-based request in the form of a claim or document. The first entity may be a healthcare facility such as a hospital or clinic, or even a specialty group within a facility. A person responsible for submitting claims prepares the text-based request in some embodiments, and submits them to a second entity, which applies rules to deny or accept the claim. There may be nuances to the rules applied in the second entity which can make it difficult to determine why a claim was denied or accepted. While the first entity may be aware of the rules, the rules can be nuanced and complex, creating difficulty in understanding reasons for the disposition of a claim. The first entity may also forget data that they know is required, such as a diagnosis. Processing a prepared request via computer implemented method 100 may quickly reveal the error prior to submitting the request for approval.

The below requests may be used as training data for the system. While just three are shown, there may be hundreds or thousands corresponding to a facility used to create a model or models for the facility. Different facilities may utilize different training data to create models applicable to the respective facilities.

### EXAMPLE CLAIM 1

The below request refers to a hypothetical patient with a facial laceration which was repaired. This procedure is code 12011. In this request there is missing documentation

Request: Patient A reported falling down a set of stairs and obtaining a 1 cm laceration to their forehead. There is moderate bleeding, but no signs of vomiting. The patient does not report a loss of consciousness and seems to be responding correctly to all vital signs. The laceration was addressed, and the patient was sent home with no complications.

Result: Denied

EXAMPLE CLAIM 2

The below request is another example of a hypothetical denied claim for someone with code 12011. In this case there is missing information related to an uncovered procedure in the documentation.

Request: Patient A reported falling don a set of stairs and obtaining a 1 cm laceration to their forehead. There is moderate bleeding, but no signs of vomiting. The patient does not report a loss of consciousness and seems to be responding correctly to all vital signs. The 1 cm forehead laceration was repaired using Dermabond. An X-ray was performed of the patient's head to make sure there were no fractures.

Result: Denied

EXAMPLE CLAIM 3

The below request is an example of a properly documented hypothetical example for a patient with medical code 12011.

Request: Patient A reported falling don a set of stairs and obtaining a 1 cm laceration to their forehead. There is moderate bleeding, but no signs of vomiting. The patient does not report a loss of consciousness and seems to be responding correctly to all vital signs. The 1 cm forehead laceration was repaired using Dermabond.

Result: Accepted/Approved

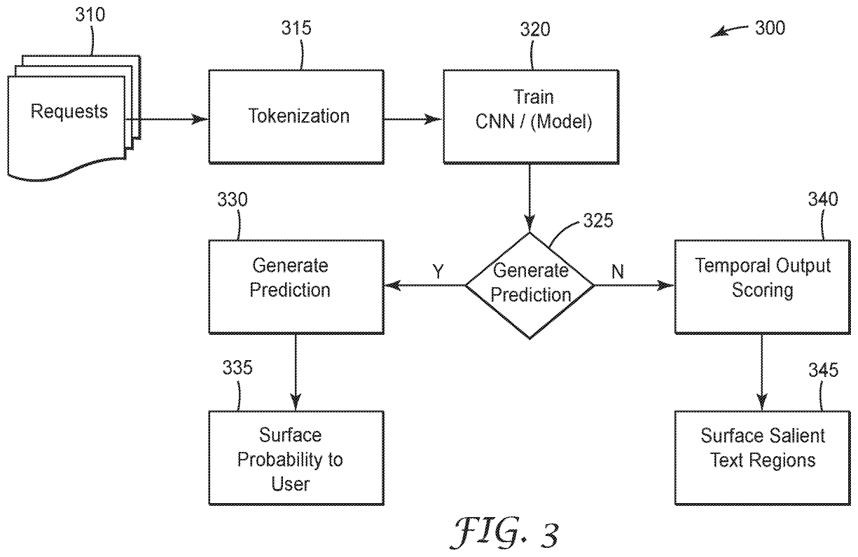

FIG. 3 is a block flow diagram 300 illustrating the training and use of a model for predicting request fate and providing identification of portions of requests that are more likely to lead to approval. Requests 310 during training comprise historical requests along with their respective dispositions, such as whether each was approved or denied. The requests are tokenized to extract features at tokenizer 315. The extracted features are then fed to a neural network 320, along with the disposition for training. Training of a neural network is discussed in further detail below.

Once trained, such as by using hundreds to thousand of requests as training data, a model has been generated, also represented at 320. The requests 310 may then include live requests that have not yet been submitted. The live requests are tokenized at tokenizer 315 and fed into the model 320. At decision operation 325, if a prediction of the fate of a request is desired, the prediction 330 from the model along with a probability of the accuracy of the prediction generated by model 320 is surfaced to the first entity at 335. A person/submitter at the first entity is then able to determine whether or not to revise the request prior to submitting to the second entity for approval. The submitter may iteratively revise and obtain predictions prior to submitting to help ensure a successful fate of the request/claim.

If at operation 325, the first entity desires to obtain more information about text that might achieve better results for requests, a temporal output scoring may be performed at operation 340. The temporal output scoring may be performed on training data to identify text regions of the training requests that have resulted in better outcomes. Many different methods of determining features and clusters of features that appeared in requests with better outcomes may be used, such as method 200. Salient text regions may be surfaced to the first entity at operation 345, such as a printout or display in various forms.

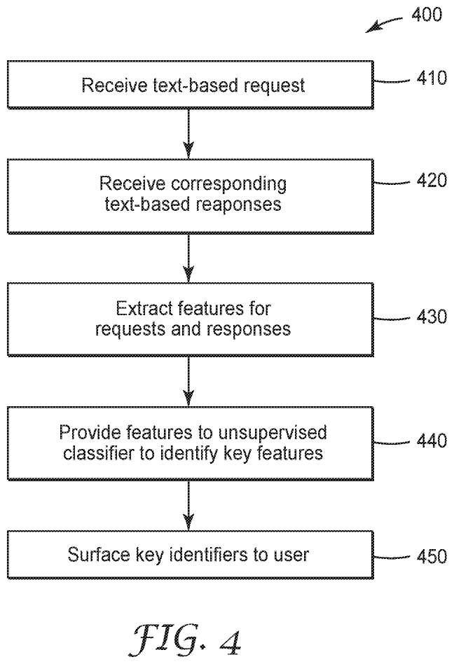

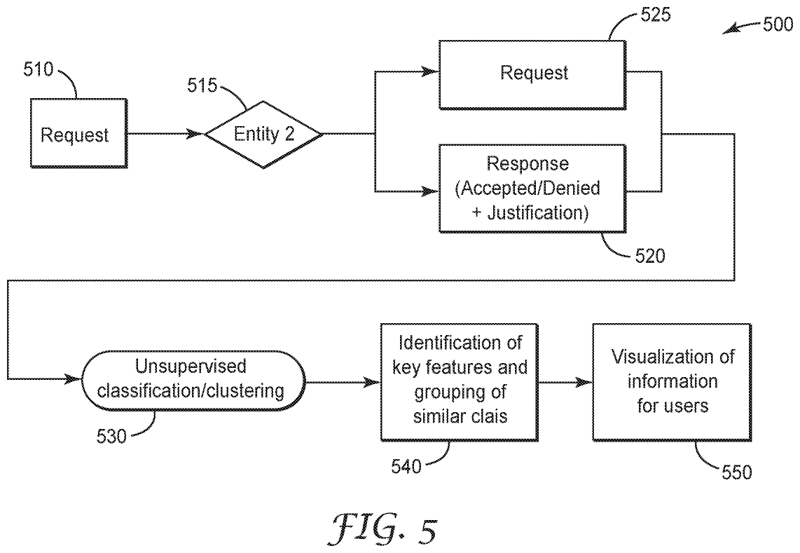

FIG. 4 is a flowchart illustrating a further computer implemented method 400 of categorizing request outcomes. Method 400 makes use of unsupervised learning to classify claims that have already been returned from the second entity. Method 400 beings at operation 410 by receiving text-based requests from a first entity for approval by a second entity-based compliance with a set of rules. At operation 420, corresponding text-based responses of the second entity-based on the text-based requests are received. The order of reception of the requests and response may vary. Features from the text-based requests and responses are extracted at operation 430. At operation 440, the extracted features are provided to an unsupervised classifier to identify key features corresponding to denials or approval by the second entity. The identified key features may be learned document embeddings from the neural network classifier, hospital wing, attending physician, coder id, or others and be color coded or otherwise provided attributes to aid in human understanding

Clustering may be used to find similar claims that were accepted or denied. Various forms of manifold based clustering algorithms may be used to find similarities in claims that were approved or that were denied. Some example clustering algorithms include spectral clustering, TSNE (t-distributed stochastic neighbor embedding), k-means clustering or hierarchical clustering.

FIG. 5 is a block flow diagram illustrating a system 500 for categorizing request outcomes. A request 510 is submitted to the second entity at 515. The second entity provides a response 520 indicating that the request was accepted/approved, or denied. A justification may also be provided. The justification may be text that describes a reason and may include an alphanumeric code in some examples. The original request may also be received as indicated at 525. The response 520 and request 525 are provided to an unsupervised classification and clustering system 530, which classifies the requests into categories using one or more of the clustering algorithms described above. Key features that distinguish the requests may be identified, with similar claims grouped at 540 highlighted. A visualization of the information is provided for users at 550 by using similar colors for clusters of text. This visualization could group documents together based on their neural word embedding similarity in a vector space, or could use things like hospital wing, attending physician, coder id, etc, or a combination of the two. The features that are clustered may be converted back to the corresponding alphanumeric text for the visualization. For example, a resulting cluster might indicate that all denied claims within that cluster originated in the same hospital wing; or that they all involved a specific procedure; or were performed by the same physician.

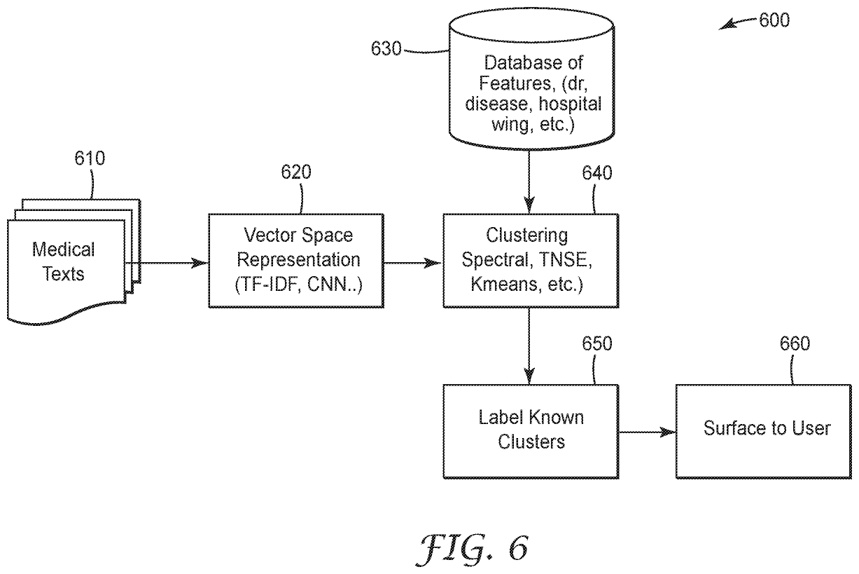

FIG. 6 is a block flow diagram 600 illustrating a further example of categorizing requests. In this example, the requests 610 are medical based texts describing a patient encounter along with the outcome of the encounter, such as a diagnosis and/or code. Requests 610 are converted into a vector space representation via an extractor 620 such as TF-IDF, CNN (convolutional neural network), or other feature extractor. A database of features 630 may include multiple different features that are applicable to medical related requests, such as individual care giver like a doctor, related disease, hospital wing, etc. A clustering function 640 is then performed using the features 630 and vector space representation from extractor 620 as input. Clustering is performed on the input as described above with labels of acceptance or denial (rejection) of the request applied to the known clusters at 650. The labeled clusters are then surfaced to a user, such as the author of the request. The labeled clusters may be presented in a color-coded manner, such that similar requests are colored the same to provide a more readily perceived presentation of the information.

Artificial intelligence (AI) is a field concerned with developing decision making systems to perform cognitive tasks that have traditionally required a living actor, such as a person. Artificial neural networks (ANNs) are computational structures that are loosely modeled on biological neurons. Generally, ANNs encode information (e.g., data or decision making) via weighted connections (e.g., synapses) between nodes (e.g., neurons). Modern ANNs are foundational to many AI applications, such as automated perception (e.g., computer vision, speech recognition, contextual awareness, etc.), automated cognition (e.g., decision-making, logistics, routing, supply chain optimization, etc.), automated control (e.g., autonomous cars, drones, robots, etc.), among others.

Many ANNs are represented as matrices of weights that correspond to the modeled connections. ANNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the ANN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the ANN processing.

The correct operation of most ANNs relies on correct weights. However, ANN designers do not generally know which weights will work for a given application. Instead, a training process is used to arrive at appropriate weights. ANN designers typically choose a number of neuron layers or specific connections between layers including circular connection, but the ANN designer does not generally know which weights will work for a given application. Instead, a training process generally proceeds by selecting initial weights, which may be randomly selected. Training data is fed into the ANN and results are compared to an objective function that provides an indication of error. The error indication is a measure of how wrong the ANN's result was compared to an expected result. This error is then used to correct the weights. Over many iterations, the weights will collectively converge to encode the operational data into the ANN. This process may be called an optimization of the objective function (e.g., a cost or loss function), whereby the cost or loss is minimized.

A gradient descent technique is often used to perform the objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the ANN—here “forward” means that the data starts at the input neurons and follows the directed graph of neuron connections until the output neurons are reached—and the objective function is applied backwards through the ANN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of ANNs.

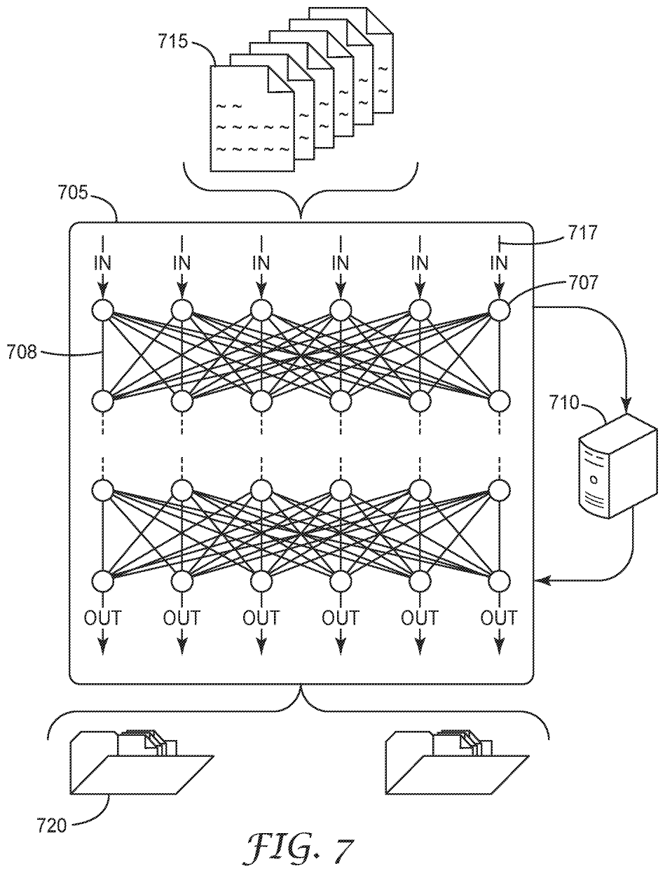

FIG. 7 is a block diagram of an example of an environment including a system for neural network training, according to an embodiment. The system includes an ANN 705 that is trained using a processing node 710. The processing node 710 may be a CPU, GPU, field programmable gate array (FPGA), digital signal processor (DSP), application specific integrated circuit (ASIC), or other processing circuitry. In an example, multiple processing nodes may be employed to train different layers of the ANN 705, or even different nodes 707 within layers. Thus, a set of processing nodes 710 is arranged to perform the training of the ANN 705.

The set of processing nodes 710 is arranged to receive a training set 715 for the ANN 705. The ANN 705 comprises a set of nodes 707 arranged in layers (illustrated as rows of nodes 707) and a set of inter-node weights 708 (e.g., parameters) between nodes in the set of nodes. In an example, the training set 715 is a subset of a complete training set. Here, the subset may enable processing nodes with limited storage resources to participate in training the ANN 705.

The training data may include multiple numerical values representative of a domain, such as red, green, and blue pixel values and intensity values for an image or pitch and volume values at discrete times for speech recognition. Each value of the training, or input 717 to be classified once ANN 705 is trained, is provided to a corresponding node 707 in the first layer or input layer of ANN 705. The values propagate through the layers and are changed by the objective function.

As noted above, the set of processing nodes is arranged to train the neural network to create a trained neural network. Once trained, data input into the ANN will produce valid classifications 720 (e.g., the input data 717 will be assigned into categories), for example. The training performed by the set of processing nodes 707 is iterative. In an example, each iteration of the training the neural network is performed independently between layers of the ANN 705. Thus, two distinct layers may be processed in parallel by different members of the set of processing nodes. In an example, different layers of the ANN 705 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 707 (e.g., neurons) are trained independently. In an example, the nodes are trained on different hardware.

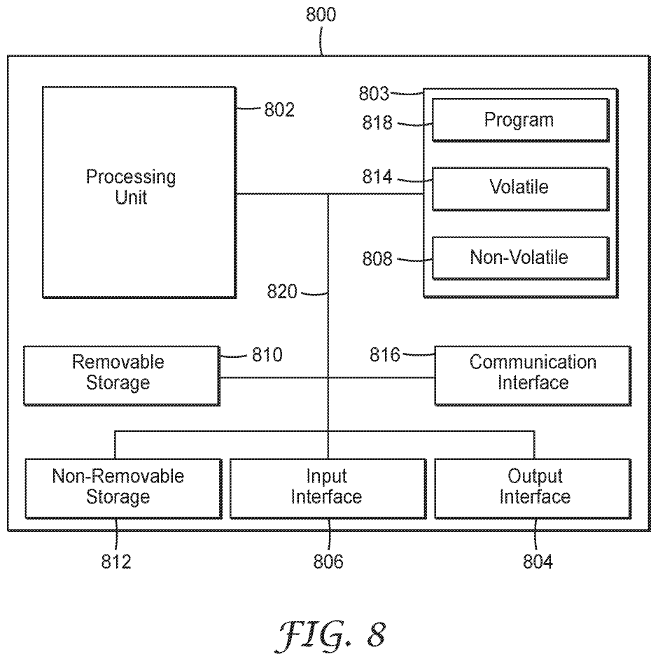

FIG. 8 is a block schematic diagram of a computer system 800 to implement request approval prediction process components and for performing methods and algorithms according to example embodiments. All components need not be used in various embodiments.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, smart storage device (SSD), or other computing device including the same or similar elements as illustrated and described with regard to FIG. 8. Devices, such as smartphones, tablets, and smartwatches, are generally collectively referred to as mobile devices or user equipment.

Although the various data storage elements are illustrated as part of the computer 800, the storage may also or alternatively include cloud-based storage accessible via a network, such as the Internet or server based storage. Note also that an SSD may include a processor on which the parser may be run, allowing transfer of parsed, filtered data through I/O channels between the SSD and main memory.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input interface 806, output interface 804, and a communication interface 816. Output interface 804 may include a display device, such as a touchscreen, that also may serve as an input device. The input interface 806 may include one or more of a touchscreen, touchpad, mouse, keyboard, camera, one or more device-specific buttons, one or more sensors integrated within or coupled via wired or wireless data connections to the computer 800, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 800 are connected with a system bus 820.

Computer-readable instructions stored on a computer-readable medium are executable by the processing unit 802 of the computer 800, such as a program 818. The program 818 in some embodiments comprises software to implement one or more of the machine learning, converters, extractors, natural language processing machine, and other devices for implementing methods described herein. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 818 along with the workspace manager 822 may be used to cause processing unit 802 to perform one or more methods or algorithms described herein.

### REQUEST DISPOSITION PREDICTION EXAMPLES

1. A computer implemented method includes receiving a text-based request from a first entity for approval by a second entity-based compliance with a set of rules, converting the text-based request to create a machine compatible converted input having multiple features, providing the converted input to a trained machine learning model that has been trained based on a training set of historical converted requests by the first entity, and receiving a prediction of approval by the second entity from the trained machine learning model along with a probability that the prediction is correct.

2. The method of example 1 wherein converting the text-based request comprises separating punctuation marks from text in the request and treating individual entities as tokens.

3. The method of example 2 wherein converting is performed by a natural language processing machine.

4. The method of any one of examples 1-3 wherein converting comprises tokenizing the text-based request to create tokens.

5. The method of example 4 wherein tokenizing the text-based request includes using inverse document frequency to form a vectorized representation of the tokens.

6. The method of example 4 wherein tokenizing the text-based request includes using neural word embeddings to form a dense word vector embedding of the tokens.

7. The method of any one of examples 1-6 wherein the trained machine learning model comprises a classification model.

8. The method of any one of examples 1-6 wherein the trained machine learning model comprises a recurrent or convolutional neural network.

9. The method of any one of examples 1-8 and further including iteratively providing different subsets of the multiple features to the trained machine learning model, receiving predictions and probabilities for each of the provided different subsets, and identifying at least one subset correlated with approval of the request.

10. The method of example 9 wherein iteratively providing different subsets of the multiple features is performed using n-gram analysis.

11. A machine-readable storage device has instructions for execution by a processor of a machine to cause the processor to perform operations to perform a method of predicting a disposition of requests. The operations include receiving a text-based request from a first entity for approval by a second entity-based compliance with a set of rules, converting the text-based request to create a machine compatible converted input having multiple features, providing the converted input to a trained machine learning model that has been trained based on a training set of historical converted requests by the first entity, and receiving a prediction of approval by the second entity from the trained machine learning model along with a probability that the prediction is correct.

12. The device of example 11 wherein converting the text-based request comprises separating punctuation marks from text in the request and treating individual entities as tokens and is performed by a natural language processing machine.

13. The device of any one of examples 11-12 wherein converting the text-based request includes using inverse document frequency to form a vectorized representation of the tokens or neural word embeddings to form a dense word vector embedding of the tokens.

14. The device of any one of examples 11-13 wherein the trained machine learning model comprises a classification model.

15. The device of any one of examples 11-13 wherein the trained machine learning model comprises a recurrent or convolutional neural network.

16. The device of any one of examples 11-15 wherein the operations further include iteratively providing different subsets of the multiple features to the trained machine learning model, receiving predictions and probabilities for each of the provided different subsets, and identifying at least one subset correlated with approval of the request.

17. The device of example 16 wherein iteratively providing different subsets of the multiple features is performed using n-gram analysis.

18. A device includes a processor and a memory device coupled to the processor and having a program stored thereon for execution by the processor to perform operation to perform a method of predicting a disposition of requests. The operations include receiving a text-based request from a first entity for approval by a second entity-based compliance with a set of rules, converting the text-based request to create a machine compatible converted input having multiple features, providing the converted input to a trained machine learning model that has been trained based on a training set of historical converted requests by the first entity, and receiving a prediction of approval by the second entity from the trained machine learning model along with a probability that the prediction is correct.

19. The device of example 18 wherein converting the text-based request comprises separating punctuation marks from text in the request and treating individual entities as tokens and is performed by a natural language processing machine and wherein converting the text-based request includes using inverse document frequency to form a vectorized representation of the tokens or using frequency—inverse document frequency to form a dense word vector embedding of the tokens.

20. The device of example 18 wherein the trained machine learning model comprises a classification model.

21. The device of any one of examples 18-20 wherein the operations further include iteratively providing different subsets of the multiple features to the trained machine learning model, receiving predictions and probabilities for each of the provided different subsets, and identifying at least one subset correlated with approval of the request.

22. The device of example 21 wherein iteratively providing different subsets of the multiple features is performed using n-gram analysis.

### REQUEST CATEGORIZATION EXAMPLES

1. A computer implemented method includes receiving text-based requests from a first entity for approval by a second entity-based compliance with a set of rules, receiving corresponding text-based responses of the second entity-based on the text-based requests, extracting features from the text-based requests and responses, and providing the extracted features to an unsupervised classifier to identify key features corresponding to denials or approval by the second entity.

2. The method of example 1 wherein converting the text-based request comprises separating punctuation marks from text in the request and treating individual entities as tokens.

3. The method of example 2 wherein converting is performed by a natural language processing machine.

4. The method of any of examples 1-3 wherein converting comprises tokenizing the text-based request to create tokens.

5. The method of example 4 wherein tokenizing the text-based request includes using inverse document frequency to form a vectorized representation of the tokens.

6. The method of example 4 wherein tokenizing the text-based request includes using neural to form embeddings to form a dense word vector embedding of the tokens.

7. The method of any of examples 1-6 wherein the unsupervised classifier comprises a convolutional neural network.

8. The method of any of examples 1-7 and further comprising performing clustering the features to find similar requests that were accepted or denied.

9. The method of example 8 wherein clustering is performed by executing a manifold based clustering algorithm.

10. The method of example 8 wherein clustering is performed by k-means clustering.

11. A machine-readable storage device having instructions for execution by a processor of a machine to cause the processor to perform operations to perform a method of categorizing requests, the operations includes receiving text-based requests from a first entity for approval by a second entity-based compliance with a set of rules, receiving corresponding text-based responses of the second entity-based on the text-based requests, extracting features from the text-based requests and responses, and providing the extracted features to an unsupervised classifier to identify key features corresponding to denials or approval by the second entity.

12. The method of example 11 wherein converting the text-based request comprises separating punctuation marks from text in the request and treating individual entities as tokens.

13. The method of example 12 wherein converting is performed by a natural language processing machine.

14. The method of any of examples 11-13 wherein converting comprises tokenizing the text-based request to create tokens.

15. The method of example 14 wherein tokenizing the text-based request includes using inverse document frequency to form a vectorized representation of the tokens.

16. The method of example 14 wherein tokenizing the text-based request includes using neural word embeddings to form a dense word vector embedding of the tokens.

17. The method of any of examples 11-16 wherein the unsupervised classifier comprises a convolutional neural network.

18. The method of any of examples 11-17 and further comprising performing clustering the features to find similar requests that were accepted or denied.

19. The method of example 18 wherein clustering is performed by executing a manifold based clustering algorithm.

20. The method of example 18 wherein clustering is performed by k-means clustering.

21. A device includes a processor and a memory device coupled to the processor and having a program stored thereon for execution by the processor to perform operation to perform a method of categorizing requests. The operations include receiving text-based requests from a first entity for approval by a second entity-based compliance with a set of rules, receiving corresponding text-based responses of the second entity-based on the text-based requests, extracting features from the text-based requests and responses, and providing the extracted features to an unsupervised classifier to identify key features corresponding to denials or approval by the second entity.

22. The method of example 21 wherein converting the text-based request comprises separating punctuation marks from text in the request and treating individual entities as tokens.

23. The method of example 22 wherein converting is performed by a natural language processing machine.

24. The method of any of examples 21-23 wherein converting comprises tokenizing the text-based request to create tokens.

25. The method of example 24 wherein tokenizing the text-based request includes using inverse document frequency to form a sparse vectorized representation of the tokens.

26. The method of example 24 wherein tokenizing the text-based request includes using neural word embeddings to form a dense word vector embedding of the tokens.

27. The method of any of examples 21-26 wherein the unsupervised classifier comprises a convolutional neural network.

28. The method of any of examples 21-27 and further comprising performing clustering the features to find similar requests that were accepted or denied.

29. The method of example 28 wherein clustering is performed by executing a manifold-based clustering algorithm.

30. The method of example 28 wherein clustering is performed by k-means clustering.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a text-based request from a first entity for approval by a second entity-based compliance with a set of rules;
converting the text-based request to create a machine compatible converted input having multiple features;
providing the converted input to a trained machine learning model that has been trained based on a training set of historical converted requests by the first entity; and
receiving a prediction of approval by the second entity from the trained machine learning model along with a probability that the prediction is correct.

2. The method of claim 1 wherein converting the text-based request comprises separating punctuation marks from text in the request and treating individual entities as tokens.

3. The method of claim 2 wherein converting is performed by a natural language processing machine.

4. The method of claim 1 wherein converting comprises tokenizing the text-based request to create tokens.

5. The method of claim 4 wherein tokenizing the text-based request includes using inverse document frequency to form a vectorized representation of the tokens.

6. The method of claim 4 wherein tokenizing the text-based request includes using neural word embeddings to form a dense word vector embedding of the tokens.

7. The method of claim I wherein the trained machine learning model comprises a classification model.

8. The method of claim l wherein the trained machine learning model comprises a recurrent or convolutional neural network.

9. The method of claim 1 and further comprising:
iteratively providing different subsets of the multiple features to the trained machine learning model;
receiving predictions and probabilities for each of the provided different subsets; and
identifying at least one subset correlated with approval of the request.

10. The method of claim 9 wherein iteratively providing different subsets of the multiple features is performed using n-gram analysis.

11. A machine-readable storage device having instructions for execution by a processor of a machine to cause the processor to perform operations to perform a method of predicting a disposition of requests, the operations comprising:
receiving a text-based request from a first entity for approval by a second entity-based compliance with a set of rules;
converting the text-based request to create a machine compatible converted input having multiple features;
providing the converted input to a trained machine learning model that has been trained based on a training set of historical converted requests by the first entity; and
receiving a prediction of approval by the second entity from the trained machine learning model along with a probability that the prediction is correct.

12. The device of claim 11 wherein converting the text-based request comprises separating punctuation marks from text in the request and treating individual entities as tokens and is performed by a natural language processing machine.

13. The device of claim 11 wherein converting the text-based request includes using inverse document frequency to form a vectorized representation of the tokens or using neural word embeddings to form a dense word vector embedding of the tokens.

14. The device of claim 11 wherein the trained machine learning model comprises a classification model.

15. The device of claim 11 wherein the trained machine learning model comprises a recurrent or convolutional neural network.

16. The device of claim 11 wherein the operations further comprise:
iteratively providing different subsets of the multiple features to the trained machine learning model;
receiving predictions and probabilities for each of the provided different subsets; and
identifying at least one subset correlated with approval of the request.

17. The device of claim 16 wherein iteratively providing different subsets of the multiple features is performed using n-gram analysis.

18. A device comprising:
a processor; and
a memory device coupled to the processor and having a program stored thereon for execution by the processor to perform operation to perform a method of predicting a disposition of requests, the operations comprising:
receiving a text-based request from a first entity for approval by a second entity-based compliance with a set of rules;
converting the text-based request to create a machine compatible converted input having multiple features;
providing the converted input to a trained machine learning model that has been trained based on a training set of historical converted requests by the first entity; and
receiving a prediction of approval by the second entity from the trained machine learning model along with a probability that the prediction is correct.

19. The device of claim 18 wherein converting the text-based request comprises separating punctuation marks from text in the request and treating individual entities as tokens and is performed by a natural language processing machine and wherein converting the text-based request includes using inverse document frequency to form a vectorized representation of the tokens or using neural word embeddings to form a dense word vector embedding of the tokens.

20. The device of claim 18 wherein the operations further comprise:
iteratively providing different subsets of the multiple features to the trained machine learning model;
receiving predictions and probabilities for each of the provided different subsets; and
identifying at least one subset correlated with approval of the request.
